(19) United States
(12) Patent Application Publication
(10) Pub. No.: US 2026/0054285 A1
(43) Pub. Date: Feb. 26, 2026

(54) APPARATUS AND METHOD FOR MANUFACTURING ELECTRODE OF SECONDARY BATTERY

(71) Applicant: SAMSUNG SDI CO., LTD., Yongin-si (KR)

(72) Inventor: Minjun KIM, Yongin-si (KR)

(21) Appl. No.: 19/097,100

(22) Filed: Apr. 1, 2025

(30) Foreign Application Priority Data
Aug. 21, 2024 (KR) 10-2024-0111767

(51) Int. Cl. B05C 11/10; B05D 1/26; H01M 4/04

(52) U.S. Cl. CPC B05C 11/1007; B05D 1/26; H01M 4/0404; B05D 2401/00

(57) ABSTRACT

An apparatus for manufacturing an electrode of a secondary battery according to embodiments of the present disclosure may include a first pipe configured to transport a first slurry and a first die connected to the first pipe by a first connecting member. The apparatus may also include a second pipe configured to transport a second slurry and a second die connected to the second pipe by a second connecting member. A slurry sensing sensor is installed at the first pipe and the second pipe to sense the first slurry and the second slurry.

### CROSS-REFERENCE TO RELATED APPLICATION

This application claims priority under 35 U.S.C § 119 to Korean Patent Application No. 10-2024-0111767, filed in the Korean Intellectual Property Office on Aug. 21, 2024, the entire contents of which are hereby incorporated by reference.

### BACKGROUND

### Technical Field

The present disclosure relates to an apparatus and a method for manufacturing an electrode of a secondary battery.

### Description of the Related Art

Secondary batteries are rechargeable batteries that are designed to be discharged and recharged multiple times. Such secondary batteries are commonly used in various applications such as electronic devices (smart phones, laptops, tablets, etc.), electric vehicles, solar power generation, and emergency power supplies. For example, lithium-ion batteries are widely used in various electronic products and electric vehicles due to their high energy density and high charge/discharge efficiency.

A secondary battery is manufactured by inserting an electrode assembly including a positive electrode plate, a negative electrode plate, and a separator into a case and sealing the case with a cap plate. The positive electrode plate is manufactured by applying a slurry for a positive electrode active material onto a substrate, and the negative electrode plate is manufactured by applying a slurry for a negative electrode active material onto the substrate.

A dual layer electrode (DLE) method has been used for a cathode slurry. In this method, upper and lower slurries to be used for coating are produced separately and the coating with the slurries is performed simultaneously. A coating die that discharges the slurries during the coating process includes three parts: an upper die, a middle die, and a lower die. The cathode upper slurry is discharged between the upper die and the middle die, and the cathode lower slurry is discharged between the middle die and the lower die. For the DLE method, an upper slurry pipe must be connected to a pipe between the upper and middle dies, and a lower slurry pipe must be connected to a pipe between the middle and lower dies. However, the upper slurry and the lower slurry are impossible to distinguish with the naked eye. Therefore, it is desirable to find a way to prevent misconnection based on a difference in the properties of the slurries themselves, such as rheological properties.

The above information disclosed in this Background section is for enhancement of understanding of the background of the present disclosure, and therefore, it may contain information that does not constitute related (or prior) art.

### SUMMARY

The present disclosure provides an apparatus and a method for manufacturing an electrode of a secondary battery to solve the above-mentioned problem.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

An apparatus for manufacturing an electrode of a secondary battery according to embodiments of the present disclosure includes a first pipe configured to transport a first slurry, a first die connected to the first pipe by a first connecting member, a second pipe configured to transport a second slurry, a second die connected to the second pipe by a second connecting member, and a slurry sensor installed at the first pipe and the second pipe, the slurry sensor being configured to sense the first slurry and the second slurry.

According to embodiments, the slurry sensing sensor may include a first slurry sensor configured to sense the first slurry and installed at the first pipe and a second slurry sensor configured to sense the second slurry and installed at the second pipe.

According to embodiments, the apparatus may further include an interlock connected to each of the first connecting member and the second connecting member and operating based on sensing by the first slurry sensor or the second slurry sensor.

According to embodiments, the interlock may generate an alarm when operating.

According to embodiments, the first and second slurry sensors are speed sensing sensors configured to sense speeds at which the first and second slurries are transported.

According to embodiments, the first and second slurry sensors are viscosity sensing sensors configured to sense the viscosities the first and second slurries.

According to embodiments, the apparatus may further include a pump for introducing the first slurry into the first pipe and a pump for introducing the second slurry into the second pipe.

According to embodiments, wherein the apparatus is configured such that when a predetermined speed for the first slurry is sensed by the first slurry sensor or a predetermined speed for the second slurry is sensed by the second slurry sensor, the interlock may not be operated.

According to embodiments, wherein the apparatus is configured such that when a predetermined speed for the second slurry is sensed by the first slurry sensor or a predetermined speed for the first slurry is sensed by the second slurry sensor, the interlock may be operated.

According to embodiments, the apparatus is configured such that when a predetermined viscosity for the first slurry is sensed by the first slurry sensor or a predetermined viscosity for the second slurry is sensed by the second slurry sensor, the interlock may not be operated.

According to embodiments, when a predetermined viscosity for the second slurry is sensed by the first slurry sensing sensor or a predetermined viscosity for the first slurry is sensed by the second slurry sensing sensor, the interlock may be operated.

According to embodiments, the first pipe and the second pipe may have the same diameter.

According to embodiments, the apparatus may include a supporting unit positioned under the second die.

A method of manufacturing an electrode of a secondary battery according to another embodiment of the present disclosure includes connecting a first pipe for transporting a first slurry to a first die through a first connecting member, connecting a second pipe for transporting a second slurry to a second die through a second connecting member, and installing a slurry sensor at the first and second pipes to sense the first and second slurries.

According to embodiments, the method may further include installing an interlock that operates based on a signal sensed by the slurry sensor.

According to embodiments, the interlock may block the transport of slurries in the first and second pipes when the slurry sensor senses an abnormality in the slurries.

According to embodiments, the slurry sensor may include at least one of a speed sensor for sensing a speed at which each of the first and second slurries is transported and a viscosity sensor for sensing a viscosity of each of the first and second slurries.

According to embodiments, an ingredient content of the first slurry is different from an ingredient content of the second slurry.

According to embodiments, a viscosity of the first slurry is greater than a viscosity of the second slurry.

According to embodiments, a speed of the first slurry is slower than a speed of the second slurry.

According to various embodiments of the present disclosure, it is possible to prevent upper and lower slurries from being reversed due to a pipe misconnection in a wet plate slurry coating process.

According to various embodiments of the present disclosure, it is possible to prevent upper and lower slurries from being reversed based on a difference in the rheological properties of the slurries.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates an apparatus for manufacturing an electrode of a secondary battery according to embodiments of the present disclosure.

FIG. 2 illustrates a coating apparatus according to embodiments of the present disclosure.

FIG. 3 is a schematic view for illustrating the coating apparatus according to embodiments of the present disclosure.

FIG. 4 illustrates a coating apparatus according to another embodiment of the present disclosure.

FIG. 5 illustrates a coating apparatus according to another embodiment of the present disclosure.

FIG. 6 illustrates a coating apparatus according to embodiments of the present disclosure in a case where pipes are incorrectly connected.

FIG. 7 illustrates a secondary battery including an electrode manufactured by an apparatus for manufacturing an electrode of a secondary battery according to embodiments of the present disclosure.

FIG. 8 is a flowchart for illustrating a method of manufacturing an electrode of a secondary battery according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

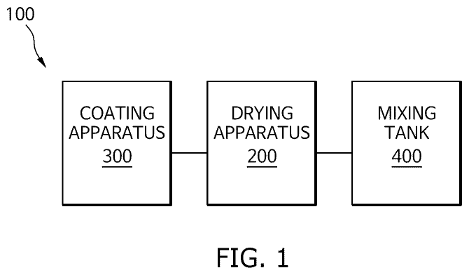

FIG. 1 illustrates an apparatus for manufacturing an electrode of a secondary battery according to embodiments of the present disclosure.

Referring to FIG. 1, the apparatus for manufacturing an electrode of a secondary battery according to embodiments may include a coating apparatus 200, a drying apparatus 300, and a mixing tank 400.

Slurry for manufacturing a secondary battery electrode may be prepared and then stored in the mixing tank 400. The slurry may be prepared by mixing a solvent, an active material, a conductive agent, and a binder. For example, the slurry may be for a positive electrode active material or for a negative electrode active material. The slurry stored in the mixing tank 400 may be supplied to the coating apparatus through a connecting pipe.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3 -f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol%, greater than or equal to about 85 mol%, greater than or equal to about 90 mol%, greater than or equal to about 91 mol%, or greater than or equal to about 94 mol% and less than or equal to about 99 mol% based on 100 mol% of the metal excluding lithium in the lithium transition metal composite oxide. The high-nickel-based positive electrode active material may be capable of realizing high capacity and can be applied to a high-capacity, high-density rechargeable lithium battery.

The positive electrode active material may be used to manufacture a positive electrode for a lithium secondary battery. A positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

The positive electrode may further include an additive that can serve as a sacrificial positive electrode.

An amount of the positive electrode active material may be about 90 wt% to about 99.5 wt% based on 100 wt% of the positive electrode active material layer. Amounts of the binder and the conductive material may be about 0.5 wt% to about 5 wt%, respectively, based on 100 wt% of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but the present disclosure is not limited thereto.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The negative electrode active material may be used to manufacture a negative electrode for a lithium secondary battery. The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

The negative electrode active material layer may include about 90 wt% to about 99 wt% of the negative electrode active material, about 0.5 wt% to about 5 wt% of the binder, and about 0 wt% to about 5 wt% of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

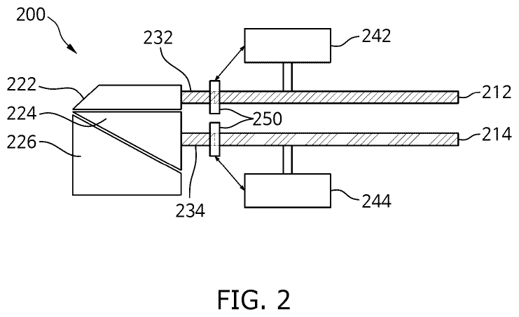

In embodiments of the present disclosure, the coating apparatus 200 may perform a coating process by applying slurry supplied from the mixing tank 400 onto a substrate. A slurry measuring unit of the coating apparatus 200 may measure the flow rate and density of the slurry. A controller of the coating apparatus 200 may control a supply unit of the coating apparatus 200 based on the flow rate and density of the slurry, which have been measured by the slurry measuring unit. The components of the coating apparatus 200 will be described in detail with reference to FIG. 2.

The drying apparatus 300 may dry slurry applied onto the surface of a substrate to form an active material layer. The drying apparatus 300 may be positioned at the rear of a die coater in the direction in which a substrate advances so that an electrode plate coated with slurry may be introduced into the drying apparatus 300. While the electrode plate passes through the drying apparatus 300, a solvent in the slurry may be evaporated by hot air discharged from the drying apparatus 300. The drying apparatus 300 may be a length sufficient to completely dry the slurry. The drying apparatus 300 may be used in a wet process, but the present disclosure is not limited thereto. For example, a secondary battery electrode may be manufactured in a dry process using only the coating apparatus 200 and the mixing tank 400 without the drying apparatus 300.

FIG. 2 illustrates a coating apparatus according to embodiments of the present disclosure.

Referring to FIG. 2, the coating apparatus 200 may include pipes 212 and 214, dies 222 and 224, a supporting unit 226, slurry sensors 242 and 244, and an interlock 250.

In the present disclosure, “connected,” means that components are either directly connected to each other or connected to each other through a separate connecting pipe. For example, when a first pipe 212 and a first die 222 are said to have been connected to each other, it may mean that respective ports of the first pipe 212 and the first die 222 are directly connected to each other, that they are connected to each other through a connecting pipe, or that they are connected to each other through a connecting pipe and an additional component such as a flow control valve and a pump.

The first pipe 212 may be a component for moving a first slurry. The first pipe 212 may be connected to the first die 222, and the first pipe 212 may be connected to the first die 222 by a first connecting member 232. A second pipe 214 may be a component for moving a second slurry. The second pipe 214 may be connected to a second die 224, and the second pipe 214 may be connected to the second die 224 by a second connecting member 234. The first pipe 212 and the second pipe 214 may have the same diameter. The second die 224 may be placed under the first die 222. The supporting unit 226 may be positioned under the second die 224, with the supporting unit 226 supporting the first die 222 and the second die 224 from below.

The ingredient content of the first slurry may be different from the ingredient content of the second slurry. Because the ingredient contents of the two slurries may be different from each other, the positions where they are each discharged may be different from each other. That is, the first slurry may be discharged between the first die 222 and the second die 224. The first slurry may be discharged outward between a lower surface of the first die 222 and an upper surface of the second die 224. The second slurry may be discharged between the second die 224 and the supporting unit 226. The second slurry may be discharged outward between a lower surface of the second die 224 and an upper surface of the supporting unit 226.

The slurry sensors 242 and 244 may be installed at the first pipe 212 and the second pipe 214. The slurry sensors 242 and 244 may be configured for sensing slurry flowing in the first pipe 212 and the second pipe 214. The slurry sensors 242 and 244 may include a first slurry sensor 242 and a second slurry sensor 244. The first slurry sensor 242 may be connected to the first pipe 212 and may sense the first slurry. The second slurry sensor 244 may be connected to the second pipe 214 and may sense the second slurry.

The interlock 250 may operate based on signals of the slurry sensors 242 and 244. The interlock 250 may be placed at each point where the connecting members 232 and 234 are connected to the pipes 212 and 214. When the slurry sensors 242 and 244 senses an abnormal flow of slurry, a signal regarding the abnormal flow may be transmitted to the controller (not shown). The controller may send a blocking signal to the interlock 250. The controller may control the interlock 250. The controller may allow the interlock 250 to block the flow of slurry. The interlock 250 and the slurry sensors 242 and 244 may be connected to each other by wired or wireless communication. In addition, the interlock 250 may be designed to generate an alarm when operating. For example, the interlock 250 may generate a sound, an LED signal, etc. to notify an operator of the abnormal flow of slurry.

According to embodiments of the present disclosure, the first slurry and the second slurry may have different ingredient contents and may thus have different viscosities. For example, the viscosity of the first slurry may be greater than the viscosity of the second slurry. More specification, due to a cathode binder solvent such as styrene-butadiene rubber (SBR), the viscosity of the first slurry may be greater than that of the second slurry. The solid content of a cathode slurry may be about 53.5 to 57 wt%, and the viscosity thereof is about 3,000 cPs. But the SBR is an aqueous binder with a solid content of 40 wt% and have a viscosity of approximately 50 cPs. Thus, as the SBR content in a cathode slurry increases, the viscosity of the cathode slurry decreases. The SBR content in a first cathode slurry with a total weight of 886 kg may be 4.04 kg and a second cathode slurry with a total weight of 910 kg may contain 37.35 kg of the SBR. In some embodiments, the content of the SBR with low solid content and viscosity is greater in the second slurry, so the viscosity of the first slurry may be greater as a whole.

When the viscosity of the first slurry is greater than that of the second slurry, the speed of the first slurry in the first pipe may be slower than that of the second slurry in the side pipe. That is, there may be a difference between the speed of the first slurry and that of the second slurry.

According to embodiments of the present disclosure, the slurry sensors 242 and 244 may be speed sensors. A predetermined speed for the first slurry may be input into the first slurry sensor 242. A predetermined speed for the second slurry may be input into the second slurry sensor 244. Accordingly, in some situations when the speed of the first slurry is sensed by the first slurry sensor 242 or the speed of the second slurry is sensed by the second slurry sensor 244, the interlock may not operate because the slurry transport through pipe connections is normal. In such situations, the speed of slurries may be within the range of speeds at which the slurries are intended flow.

In other situations, when the speed of the first slurry is sensed by the first slurry sensor 242 or the speed of the second slurry is sensed by the second slurry sensor 244, the controller may send a signal to the interlock 250. After the interlock 250 has received the signal, it may operate to block the flow of the slurries. That is, the interlock 250 may block the flow of the slurry and notify an operator of a pipe misconnection.

According to embodiments of the present disclosure, the slurry sensors 242 and 244 may be a flowmeter. The flowmeters may measure the volume per hour or the weight per hour of slurries passing through the pipes. For example, the flowmeters may include at least one of a Coriolis flowmeter, an ultrasonic flowmeter, and an electromagnetic flowmeter. However, the present disclosure is not limited to such examples.

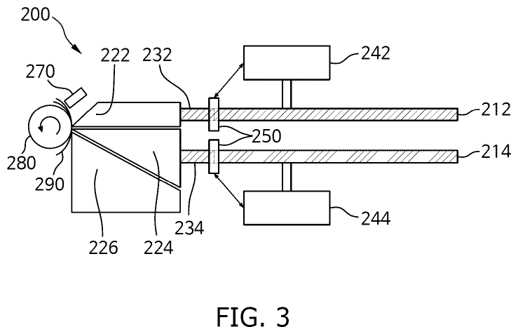

FIG. 3 is a schematic view of a coating apparatus according to embodiments of the present disclosure.

Referring to FIG. 3, the coating apparatus 200 may include pipes 212 and 214, dies 222 and 224, the supporting unit 226, the slurry sensors 242 and 244, the interlock 250, a coating quality measuring apparatus 270, and a backup roll 280.

The first pipe 212 may be configured for moving the first slurry. The first pipe 212 may be connected to the first die 222 by the first connecting member 232. The second pipe 214 may be configured for moving the second slurry. The second pipe 214 may be connected to the second die 224 by the second connecting member 234. The second die 224 may be placed under the first die 222. The supporting unit 226 may be positioned under the second die 224. The supporting unit 226 may be configured for supporting the first die 222 and the second die 224 from below.

The slurry sensors 242 and 244 may be installed at the first pipe 212 and the second pipe 214. The slurry sensors 242 and 244 may be configured for sensing slurry flowing in the first pipe 212 and the second pipe 214. The slurry sensors 242 and 244 may include the first slurry sensor 242 and the second slurry sensor 244. The first slurry sensor 242 may be connected to the first pipe 212 and may sense the first slurry. The second slurry sensor 244 may be connected to the second pipe 214 and may sense the second slurry.

The interlock 250 may operate based on signals of the slurry sensors 242 and 244. The interlock 250 may be positioned where the connecting members 232 and 234 are connected to the pipes 212 and 214. When at least one of the slurry sensors 242 and 244 senses an abnormal flow of slurry, a signal regarding the abnormal flow may be transmitted to the controller. The controller may then send a blocking signal to the interlock 250. That is, the controller may control the interlock 250. The controller may thereby cause the interlock 250 to block the flow of slurry. The interlock 250 and the slurry sensors 242 and 244 may be connected to each other by wired or wireless communication. In addition, the interlock 250 may be designed to generate an alarm when operating. For example, the interlock 250 may generate a sound, an LED signal, etc. to notify an operator of the abnormal flow of slurry.

The first slurry may be discharged between the first die 222 and the second die 224. in particular, the first slurry may be discharged outward from between the lower surface of the first die 222 and the upper surface of the second die 224. The second slurry may be discharged between the second die 224 and the supporting unit 226. in particular, the second slurry may be discharged outward from between the lower surface of the second die 224 and the upper surface of the supporting unit 226. For example, as the backup roll 280 rotates, a cathode upper slurry discharged from between the lower surface of the first die 222 and the upper surface of the second die 224 and a cathode lower slurry discharged from between the second die 224 and the supporting unit 226 may be applied onto the surface of a substrate 290.

In embodiments, the controller may receive data about a coating layer applied to the substrate 290 from the coating quality measuring apparatus 270. For example, the controller may receive data about the thickness and width of the coating layer applied to the substrate 290 from the coating quality measuring apparatus 270.

In embodiments, the first die 222 and the second die 224 may each include a slit-shaped nozzle. Slurry may be discharged through the nozzles of the first die 222 and the second die 224 to be applied to the substrate 290. For example, as the backup roll 280 rotates, the substrate 290 may be positioned adjacent to the first die 222 and the second die 224, and slurry may be applied to the surface of the substrate 290.

In embodiments, the first die 222 and the second die 224 may include a gap adjusting module. The gap adjusting module may adjust the gap between upper and lower portions of the nozzles to control the amount of slurry discharged.

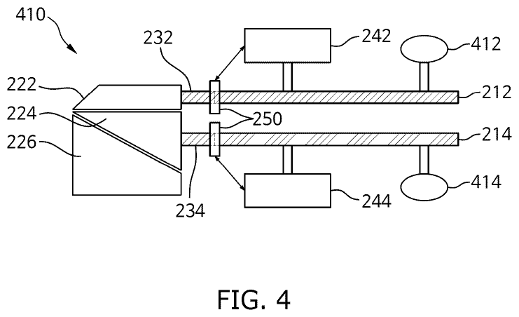

FIG. 4 illustrates a coating apparatus according to another embodiment of the present disclosure.

Referring to FIG. 4, a coating apparatus 410 may include the pipes 212 and 214, the dies 222 and 224, the supporting unit 226, the slurry sensors 242 and 244, the interlock 250, and pumps 412 and 414.

The first pipe 212 may be configured for moving a first slurry. The first pipe 212 may be connected to the first die 222 by the first connecting member 232. The second pipe 214 may be configured for moving a second slurry. The second pipe 214 may be connected to the second die 224 by the second connecting member 234. The second die 224 may be placed under the first die 222. The supporting unit 226 may be positioned under the second die 224, and the supporting unit 226 may be configured for supporting the first die 222 and the second die 224 from below.

The slurry sensors 242 and 244 may be installed at the first pipe 212 and the second pipe 214. The slurry sensors 242 and 244 may be a component for sensing slurry flowing in the first pipe 212 and the second pipe 214, respectively. More specifically, the slurry sensors 242 and 244 may include the first slurry sensor 242 and the second slurry sensor 244, with the first slurry sensor 242 being connected to the first pipe 212 to sense the first slurry and the second slurry sensor 244 being connected to the second pipe 214 to sense the second slurry.

The interlock 250 may operate based on signals from the slurry sensors 242 and 244. The interlock 250 may be positioned where the connecting members 232 and 234 are connected to the pipes 212 and 214. When the slurry sensors 242 and 244 sense an abnormal flow of slurry, a signal about the abnormal flow may be transmitted to the controller. The controller may send a blocking signal to the interlock 250. Thus, the controller may control the interlock 250 to block the flow of slurry. The interlock 250 and the slurry sensors 242 and 244 may be connected to each other by wired or wireless communication. In addition, the interlock 250 may generate an alarm when operating. For example, the interlock 250 may generate a sound, an LED signal, etc., to notify an operator of the abnormal flow of slurry.

The pump 412 and 414 may configured for introducing slurry into the pipes. The pumps 412 and 414 may include a first pump 412 and a second pump 414. The first pump 412 may be installed at the first pipe 212, and by the first pump 412, the first slurry may be introduced into the first pipe 212. The second pump 414 may be installed at the second pipe 214, and by the second pump 414, the second slurry may be introduced into the second pipe 214. The pumps may include at least one of a diaphragm pump, a gear pump, a plunger pump, and a peristaltic pump, but the present disclosure is not limited to such examples.

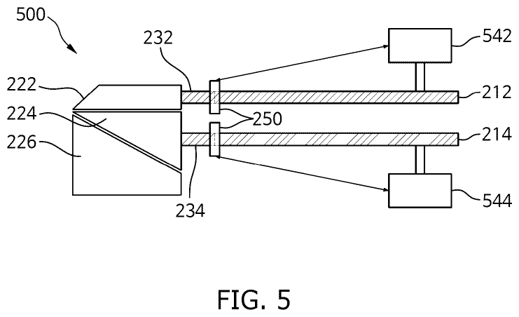

FIG. 5 illustrates a coating apparatus according to another embodiment of the present disclosure.

Referring to FIG. 5, a coating apparatus 500 may include pipes 212 and 214, dies 222 and 224, the supporting unit 226, the interlock 250, and slurry sensors 542 and 544.

The first pipe 212 may be configured for moving a first slurry, and the first pipe 212 may be connected to the first die 222 by the first connecting member 232. The second pipe 214 may be configured for moving a second slurry, and the second pipe 214 may be connected to the second die 224 by the second connecting member 234. The second die 224 may be placed under the first die 222 and under the second die 224. That is, the supporting unit 226 may be a component for supporting the first die 222 and the second die 224 from below.

The slurry sensors 542 and 544 may be installed at the first pipe 212 and the second pipe 214. The slurry sensors 542 and 544 may be configured to sense slurry flowing in the first pipe 212 and the second pipe 214, respectively. The slurry sensors 542 and 544 may include a first slurry sensor 542 and a second slurry sensor 544. The first slurry sensor 542 may be connected to the first pipe 212 to sense the first slurry and the second slurry sensor 544 may be connected to the second pipe 214 to sense the second slurry.

The interlock 250 may operate based on signals from the slurry sensors 542 and 544. The interlock 250 may be positioned where the connecting members 232 and 234 are connected to the pipes 212 and 214. When at least one of the slurry sensors 542 and 544 senses an abnormal flow of slurry, a signal regarding the abnormal flow may be transmitted to the controller. The controller may the send a blocking signal to the interlock 250. That is, the controller may control the interlock 250 to block the flow of slurry. The interlock 250 and the slurry sensors 542 and 544 may be connected to each other by wired or wireless communication. In addition, the interlock 250 may be designed to generate an alarm when operating. For example, the interlock 250 may generate a sound, an LED signal, etc., to notify an operator of the abnormal flow of slurry.

According to embodiments of the present disclosure, the first slurry and the second slurry may have different ingredient contents and may thus have different viscosities. For example, the viscosity of the first slurry may be greater than the viscosity of the second slurry. More specifically, due to a cathode binder solvent such as SBR, the viscosity of the first slurry may be greater than that of the second slurry. The solid content of a cathode slurry may be about 53.5 to 57 wt%, and the viscosity thereof is about 3,000 cPs. But the SBR is an aqueous binder with a solid content of 40 wt% and has a viscosity of approximately 50 cPs. Thus, as the SBR content in a cathode slurry increases, the viscosity of the cathode slurry decreases. The SBR content in a first cathode slurry with a total weight of 886 kg may be 4.04 kg, and second cathode slurry with a total weight of 910 kg may contain 37.35 kg of the SBR. In some embodiments, the content of the SBR with low solid content and viscosity is greater in the second slurry, so the viscosity of the first slurry may be greater as a whole.

According to embodiments of the present disclosure, the slurry sensors 542 and 544 may be viscosity sensors. A predetermined viscosity, e.g., as a range of viscosities, for the first slurry may be input into the first slurry sensor 542. A predetermined viscosity for the second slurry may be input into the second slurry sensor 544. Accordingly, in some situations when the viscosity of the first slurry is sensed by the first slurry sensor 542 or the viscosity of the second slurry is sensed by the second slurry sensor 544, the interlock may not operate because the slurry transport through the pipe connections is normal.

In other situations, when the viscosity of the first slurry is sensed by the first slurry sensor 542 or the viscosity of the second slurry is sensed by the second slurry sensor 544, the controller may send an operation signal to the interlock 250. After the interlock 250 has received the signal, it may operate to block the flow of the slurries. That is, the interlock 250 may block the flow of the slurry and notify an operator of a pipe misconnection.

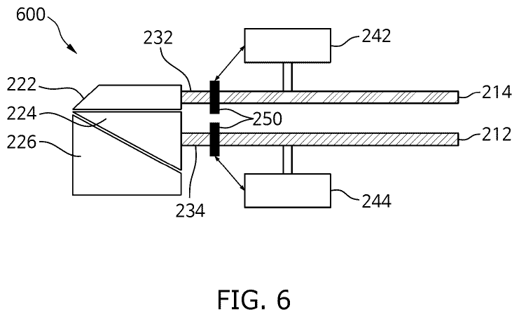

FIG. 6 illustrates a coating apparatus according to embodiments of the disclosure in a case where the pipes are incorrectly connected to the dies.

Referring to FIG. 6, the second pipe 214 is connected to the first die 222, and the first pipe 212 is connected to the second die 224. Thus, a second slurry is sent into the second pipe 214, and a first slurry is sent into the first pipe 212.

A predetermined speed or viscosity of the first slurry may be input into the first slurry sensor 242. A predetermined speed or viscosity of the second slurry may be input into the second slurry sensor 244. Thus, the first slurry sensor 242 may sense the speed or viscosity of the second slurry flowing in the second pipe 214 and thereby sense an abnormal speed and viscosity. The first slurry sensing sensor 242 then may transmit a signal for operating the interlock 250 to the controller. After the interlock 250 receives the signal, it may operate to block the flow of the second slurry. The interlock 250 may notify an operator of an incorrect connection by an audible alarm, an LED signal, etc. Also, the second slurry sensor 244 may sense the speed or viscosity of the first slurry flowing in the first pipe 212 and thereby sense an abnormal speed and viscosity. The second slurry sensor 244 may transmit a signal for operating the interlock 250 to the controller, and the interlock 250 may be operated to block the flow of the first slurry. After the interlock 250 has received the signal, it may notify an operator of an incorrect connection by an audible alarm, an LED signal, etc.

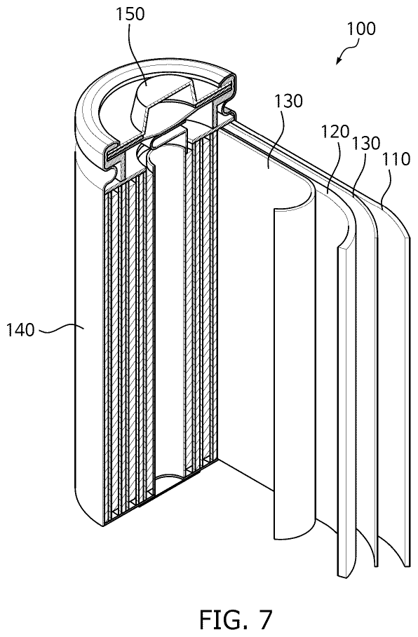

FIG. 7 illustrates a secondary battery including an electrode manufactured by an apparatus for manufacturing an electrode of a secondary battery according to embodiments of the present disclosure.

Referring to FIG. 7, a secondary battery 100 may include an electrode assembly, a case 140 accommodating the electrode assembly and an electrolyte therein, and a cap assembly 150 coupled to an opening of the case 140 to seal the case 140.

The electrode assembly may include a separator 130 and a first electrode 120 and a second electrode 110 positioned with the separator interposed therebetween. The electrode assembly may be wound, folded, or stacked to be accommodated in the case 140. Although FIG. 1 shows the case 140 in a cylindrical shape, the present disclosure is not limited to such a shape. For example, the case 140 of the secondary battery 100 according to the present disclosure may be a cylindrical shape, a square shape, a pouch shape, or a circular shape.

The first electrode 120 may include a first collector plate and a first active material layer positioned on the first collector plate. The first active material layer may be formed by the apparatus and method for manufacturing an electrode of a secondary battery according to some embodiments of the present disclosure. A first tab may extend outward from a first non-coating portion of the first collector plate where the first active material layer is not placed. The first tab may be electrically connected to the cap assembly 150 or the case 140.

The second electrode 110 may include a second collector plate and a second active material layer positioned on the second collector plate. The second active material layer may be formed by the apparatus and method for manufacturing an electrode of a secondary battery according to some embodiments of the present disclosure. A second tab may extend outward from a second non-coating portion of the second collector plate where the second active material layer is not placed. The second tab may be electrically connected to the cap assembly 150 or the case 140. In embodiments, the first tab and the second tab may extend in opposite directions. In another embodiment, the first tab and the second tab may extend in the same direction.

In some embodiments, the first electrode 120 may serve as an anode. In such a case, the first collector plate may be made of, for example, aluminum foil, and the first active material layer may include, for example, a transition metal oxide. The second electrode 110 may serve as a cathode. In such a case, the second collector plate may be made of, for example, copper foil or nickel foil, and the second active material layer may include, for example, graphite.

According to some embodiments, a plurality of secondary batteries 100 may be stacked to form a battery pack. Such a battery pack may be used for a device required to have high capacity and high output. For example, such a battery pack can be used for laptops, smartphones, electric vehicles, etc.

The secondary battery 100 may be a lithium secondary battery, a sodium secondary battery, etc. However, the present disclosure is not limited to such examples, and the secondary battery 100 includes all batteries that can provide electricity with repeated charging and discharging. In embodiments, when the secondary battery 100 is a lithium secondary battery, it can be used for an electric vehicle (EV) because it has excellent life properties and high-rate properties. For example, it can be used for a hybrid vehicle such as a plug-in hybrid electric vehicle (PHEV). In addition, lithium secondary batteries can be used in applications where a large amount of stored power is required. For example, they can be used for electric bicycles, power tools, etc.

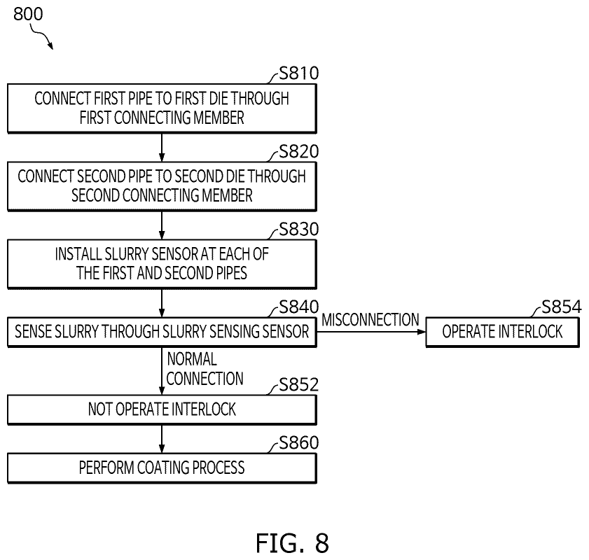

FIG. 8 is a flowchart for illustrating a method of manufacturing an electrode of a secondary battery according to embodiments of the present disclosure.

A method 800 of manufacturing an electrode of a secondary battery may be performed by the apparatus for manufacturing an electrode of a secondary battery according to embodiments of the present disclosure.

Referring to FIG. 8, a first pipe for transporting a first slurry may be connected to a first die by a first connecting member at S810. A second pipe for transporting a second slurry may be connected to a second die by a second connecting member at S820. An interlock may be installed at each point where the first connecting member and the second connecting member are connected to the first pipe and the second pipe, respectively. A slurry sensor may be installed at each of the first pipe and the second pipe at S830.

The first slurry may be sent to the first die through the first pipe, and the second slurry may be sent to the second die through the second pipe. The movement of the first slurry and the second slurry may be sensed by the slurry sensors each installed at the first and second pipes at S840. The slurry sensors may sense the speed and/or viscosity of the slurry. When the slurry sensors has sensed a normal speed or viscosity of the slurry, it may determine that the pipes and the dies have been correctly connected to each other, and the slurry sensing sensors may transmit a normal operation signal to a controller. in such a case, the controller may not transmit a signal for operating the interlock at S852. The first slurry may be sent to the first die through the first pipe and the second slurry may be sent to the second die through the second pipe. The slurry may be applied onto a substrate by the apparatus for manufacturing an electrode of a secondary battery at S860.

When at least one of the slurry sensing sensors has sensed an abnormal speed or viscosity of the slurries, it may determine that the pipe and the die have been incorrectly connected. The slurry sensing sensors may transmit an abnormal operation signal to the controller, and the controller may transmit a signal for operating the interlock. The interlock may be activated at S854 to thereby stop the transport of the slurry. It is therefore possible to prevent the slurries from being reversed and sent to the incorrect dies. The interlock may operate to send an alarm regarding the pipe misconnection to an operator.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. An apparatus for manufacturing an electrode of a secondary battery, the apparatus comprising:
a first pipe configured to transport a first slurry;
a first die connected to the first pipe by a first connecting member;
a second pipe configured to transport a second slurry;
a second die connected to the second pipe by a second connecting member; and
a slurry sensor installed at the first pipe and the second pipe, the slurry sensor being configured to sense the first slurry and the second slurry.

2. The apparatus as claimed in claim 1, wherein the slurry sensing sensor comprises:
a first slurry sensor configured to sense the first slurry and installed at the first pipe; and
a second slurry sensor configured to sense the second slurry and installed at the second pipe.

3. The apparatus as claimed in claim 2, further comprising an interlock connected to each of the first connecting member and the second connecting member and operating based on sensing by the first slurry sensor or based on sensing by the second slurry sensor.

4. The apparatus as claimed in claim 3, wherein the interlock generates an alarm when operating.

5. The apparatus as claimed in claim 3, wherein the first and second slurry sensors are speed sensing sensors configured to sense speeds at which the first and second slurries are transported.

6. The apparatus as claimed in claim 3, wherein the first and second slurry sensors are viscosity sensing sensors configured to sense viscosities of the first and second slurries.

7. The apparatus as claimed in claim 1, further comprising a pump for introducing the first slurry into the first pipe and a pump for introducing the second slurry into the second pipe.

8. The apparatus as claimed in claim 5, wherein, the apparatus is configured such that when a predetermined speed for the first slurry is sensed by the first slurry sensor or a predetermined speed for the second slurry is sensed by the second slurry sensor, the interlock is not operated.

9. The apparatus as claimed in claim 5, wherein, the apparatus is configured such that when a predetermined speed for the second slurry is sensed by the first slurry sensor or a predetermined speed for the first slurry is sensed by the second slurry sensor, the interlock is operated.

10. The apparatus as claimed in claim 6, wherein, the apparatus is configured such that when a predetermined viscosity for the first slurry is sensed by the first slurry sensor or a predetermined viscosity for the second slurry is sensed by the second slurry sensor, the interlock is not operated.

11. The apparatus as claimed in claim 6, wherein, the apparatus is configured such that when a predetermined viscosity for the second slurry is sensed by the first slurry sensor or a predetermined viscosity for the first slurry is sensed by the second slurry sensor, the interlock is operated.

12. The apparatus as claimed in claim 1, wherein the first pipe and the second pipe have the same diameter.

13. The apparatus as claimed in claim 1, further comprising a supporting unit positioned under the second die.

14. A method of manufacturing an electrode of a secondary battery, the method comprising:
connecting a first pipe for transporting a first slurry to a first die through a first connecting member;
connecting a second pipe for transporting a second slurry to a second die through a second connecting member; and
installing a slurry sensor at the first and second pipes to sense the first and second slurries.

15. The method as claimed in claim 14, further comprising installing an interlock that operates based on a signal from the slurry sensing sensor.

16. The method as claimed in claim 15, wherein the interlock blocks the transport of slurries in the first and second pipes when the slurry sensing sensor senses an abnormality in the slurries.

17. The method as claimed in claim 15, wherein the slurry sensor comprises at least one of a speed sensor for sensing a speed at which each of the first and second slurries is transported and a viscosity sensor for sensing a viscosity of each of the first and second slurries.

18. The method as claimed in claim 17, wherein an ingredient content of the first slurry is different from an ingredient content of the second slurry.

19. The method as claimed in claim 17, wherein a viscosity of the first slurry is greater than a viscosity of the second slurry.

20. The method as claimed in claim 17, wherein a speed of the first slurry is slower than a speed of the second slurry.
